(19) United States
(12) Patent Application Publication
(10) Pub. No.: US 2024/0214464 A1
(43) Pub. Date: Jun. 27, 2024

(54) CONTEXTUAL COLLABORATION FOR CONFERENCING SYSTEMS, METHODS, AND DEVICES

(71) Applicant: META PLATFORMS, INC., Menlo Park, CA (US)

(72) Inventors: Aditya Satyanarayana Goteti, Cupertino, CA (US); Nabeel Ahmed, San Jose, CA (US)

(21) Appl. No.: 18/504,061

(22) Filed: Nov. 7, 2023

Related U.S. Application Data
(60) Provisional application No. 63/434,405, filed on Dec. 21, 2022.

(51) Int. Cl. H04L 67/54; H04L 65/403

(52) U.S. Cl. CPC H04L 67/54; H04L 65/403

(57) ABSTRACT

Systems and methods for providing contextual collaborating for conferencing are disclosed. In various examples, a system may include a computing device that may establish a remote network connection with a conferencing device configured to enable at least one of audio or visual communication between a group of participants. The computing device may communicate, via radio signals, with a device associated with, on, and/or near a first participant. The computing device may determine a location of the device based on received radio signals and may authenticate the first participant with the conferencing device to enable communication between the first participant and the group of participants. The computing device may also determine, in real time, an interaction of the first participant with the conferencing device, based on the received radio signals emitted from the device.

### CROSS-REFERENCE TO RELATED APPLICATIONS

This application claims the benefit of U.S. Provisional Application No. 63/434,405 filed Dec. 21, 2022, the entire content of which is incorporated herein by reference.

### BACKGROUND

As remote and hybrid work environments become more prevalent, methods for communication must adapt to enable collaboration. Videoconferencing systems enable audio and video communications between individuals who may be located at different locations. Content, such as papers, slides, graphs, whiteboard drawings, websites, or other physical or computer-based media may need to be shared between conference participants to facilitate discussion, business, or other meeting purposes. Such content sharing may easily become visually and computationally challenging, since the content must be captured, displayed, and shared in a clear manner to the group of participants.

Current methods may also face challenges in identifying participants and enabling collaboration in a realistic, natural manner. For example, a call may include multiple participants located in a room (e.g., a conference room or classroom) and potentially other remotely located users. It may be difficult for participants to identify a location of an active speaker, who is joining locally or remotely, and where local participants are located within a room. In another example, if participant on a video conference desires to collaborate with other conference participants using a physical object, like a whiteboard in a conference room, traditional conferencing systems may face challenges in transitioning from a first method of communication (e.g., the participant's laptop) to a second method of communication (e.g., a whiteboard). Many actions may be required to transition the view, associate the transition with the individual, and maintain security along the communication channel. When multiple participants desire to share content, especially content in various forms, the experience may become even more fragmented and cumbersome. As such, effectively sharing and collaborating with content remains a challenge in both in person, virtual, and hybrid conferencing environments.

### BRIEF SUMMARY

In meeting the described challenges, examples of the present disclosure provide systems, methods, and non-transitory, computer readable mediums for contextual collaboration, such as in conferences and virtual calls. In various examples, aspects of the present disclosure may establish a remote network connection with a conferencing device, the conferencing device configured to enable at least one of audio or visual communication between a group of participants, receive radio signals emitted from a device associated with a first participant, the device being located on or near the first participant, determine a location of the device based on the received radio signals, authenticate the first participant with the conferencing device to enable communication between the first participant and the group of participants, and determine, in real time, an interaction of the first participant with the conferencing device, based on radio signals emitted from the device. In various examples, radio signals emitted from the device may be monitored so that a current presence of the first participant may be updated on a display, in real time. The interaction may include at least one of a location change, a sharing of content, and a vocal interaction.

In various examples, the radio signals may be ultra-wideband radio signals. The device may be at least one of a wearable device, a headset, glasses, a watch, a mobile computing device, a laptop, or a tablet. The device location determination may utilize a location technique, such as an Angle of Arrival of the received radio signals. Various aspects may be configured to track the first participant based on the radio signals emitted from the device and provide a real time location of the first participant to the conferencing device.

According to some aspects, authenticating the first participant comprises identifying the first participant to enable, via the conferencing device, a secure communication connection between the first participant and the group of participants. receiving a request to share content from the device and providing the content to the conferencing device, for visual display to the group of participants. Various examples may be configured to receive a request to share content from the device, and provide the content to the conferencing device, for visual display to the group of participants.

In an example, aspects of the present disclosure may determine that the device is located within a proximity of a second device associated with the conferencing device, and update a location of the first participant and sharing, with the group of participants, content associated with the device or second device. The second device may further be configured to share content with the group of participants. The second device may include at least one of a camera, a whiteboard, a television, a monitor, a visual communication device, or a display.

In another example, aspects of the present disclosure may determine that a movement of the device based on the radio signals emitted from the device and provide a real time location of the first participant to the conferencing device. Communication may optionally be disabled between the first participant and the group of participants when the real time location exceeds a threshold distance. In some examples, the threshold distance is associated with a room boundary.

Various systems and methods may include a device emitting radio signals, wherein the device is associated with a first participant of a conference, the conference provided by a conferencing device enabling at least one of audio or visual communication between a group of participants, a hub configured to receive radio signals from devices, a display providing a visual representation of the group of participants, and a computing device associated with the hub, the computing device comprising a processor and at least one memory.

Aspects may further comprise an audio device comprising a plurality of distributed microphones, wherein the computing device is further configured to provide a vocal interaction from the first participant to the group of participants via a first subset of the distributed microphones, determine, based on the monitored radio signals, a change in a location of the first participant, and provide the vocal interaction from the first participant via a second subset of the distributed microphones. The second subset may comprise one or more microphones in closest proximity to the first participant. The visual representation may be a mapping of the group of participants. According to various aspects, the device may comprise a camera configured to capture content comprising at least one of an image or a video, and the computing device may be configured to securely provide the content to the conferencing device to display the content to the group of participants. The content may be securely provided via a Wi-Fi Direct (e.g., Peer-to Peer (P2P)) connection.

In one example of the present disclosure, a method is provided. The method may include establishing a remote network connection with a conferencing device. The conferencing device may be configured to enable at least one of an audio communication or a visual communication between a group of participants. The method may further include receiving radio signals emitted from a device associated with a first participant. The device may be located on or near the first participant. The method may further include determining a location of the device based on the received radio signals. The method may further include authenticating the first participant with the conferencing device to enable communication between the first participant and the group of participants. The method may further include determining, in real time, an interaction of the first participant with the conferencing device, based on the received radio signals emitted from the device.

In another example of the present disclosure, a system is provided. The system may include one or more processors and a memory including computer program code instructions. The system may also include a device emitting radio signals. The device may be associated with a first participant of a conference. The conference may be provided by a conferencing device enabling audiovisual information between participants. The system may also include a hub configured to receive radio signals from devices, such as a user device. The system may also include a display providing a visual representation of the group of participants. The system may also include a computing device associated with the hub. The computing device may comprise a processor and at least one memory configured to at least establish a remote network connection with the conferencing device. The system may also be configured to receive radio signals emitted from a device associated with a first participant. The device may be located on or near the first participant. The system may also be configured to determine a location of the device based on the received radio signals. The system may also be configured to authenticate the first participant with the conferencing device to enable communication between the first participant and the group of participants. The system may also be configured to determine, in real time, an interaction of the first participant with the conferencing device, based on the received radio signals emitted from the device.

Another example may include a system comprising an apparatus further comprising one or more processors and at least one memory including computer program code instructions. The memory and computer program code instructions are configured to, with at least one of the processors, cause the apparatus to communicate with a device via radio signals. The device may be associated with a first participant of a conference, and the conference may be provided by a conferencing device enabling at least one of an audio communication or a visual communication between a group of participants. The memory and computer program code instructions are also configured to, with at least one of the processors, cause the apparatus to establish a remote network connection with the conferencing device. The memory and computer program code instructions are also configured to, with at least one of the processors, cause the apparatus to receive the radio signals emitted from the device associated with the first participant. The device may be located on or near the first participant. The memory and computer program code instructions are also configured to, with at least one of the processors, cause the apparatus to determine a location of the device based on the received radio signals. The memory and computer program code instructions are also configured to, with at least one of the processors, cause the apparatus to authenticate the first participant with the conferencing device to enable communication between the first participant and the group of participants. The memory and computer program code instructions are also configured to, with at least one of the processors, cause the apparatus to monitor radio signals emitted from the device to update via a display, in real time, a current presence of the first participant.

In yet another example of the present disclosure, a computer program product is provided. The computer program product may include at least one non-transitory computer-readable medium including computer-executable program code instructions stored therein. The computer-executable program code instructions may cause a computing device to establish a remote network connection with a conferencing device. The conferencing device may be configured to enable at least one of an audio communication or a video communication between a group of participants. The computer-executable program code instructions may further cause the computing device to receive radio signals emitted from a device associated with a first participant. The device may be located on or near the first participant. The computer-executable program code instructions may further cause the computing device to determine a location of the device based on the received radio signals. The computer-executable program code instructions may further cause the computing device to at least authenticate the first participant with the conferencing device to enable communication between the first participant and the group of participants. The computer-executable program code instructions may further cause the computing device to at least determine, in real time, an interaction of the first participant with the conferencing device, based on radio signals emitted from the device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a contextual collaboration environment in accordance with exemplary aspects of the present disclosure.

FIG. 2 illustrates relationships between collaborative devices in accordance with exemplary aspects of the present disclosure.

FIG. 3 illustrates a flowchart for performing collaboration in accordance with exemplary aspects of the present disclosure.

FIG. 4A illustrates a flowchart a flowchart for adaptively altering content, in accordance with exemplary aspects of the present disclosure.

FIG. 4B illustrates another flowchart adaptively altering content in accordance with exemplary aspects of the present disclosure.

FIG. 5 illustrates a flowchart for sharing content in accordance with exemplary aspects of the present disclosure.

FIG. 6 illustrates an augmented reality system comprising a headset, in accordance with exemplary aspects of the present disclosure.

FIG. 7 illustrates a block diagram of an example device according to an exemplary aspect of the present disclosure.

FIG. 8 illustrates a block diagram of an example computing system according to an exemplary aspect of the present disclosure.

FIG. 9 illustrates a machine learning and training model in accordance with aspects of the present disclosure.

FIG. 10 illustrates a computing system in accordance with exemplary aspects of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular aspects by way of example only and is not intended to be limiting of the claimed subject matter.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users can socialize, collaborate, learn, shop and engage in various other activities within the virtual spaces, including through the use of Augmented/Virtual/Mixed Reality. A Metaverse may also include the in between landmarks or information in the physical world (such as, for example, location data or biometric data) to influence what is rendered in the virtual world(s).

As referred to herein, “speaker diarization” may refer to processes for analyzing audio streams and identifying speech. Such processes may include, but are not limited to parsing audio streams into segments to identify sounds and words. Speaker diarization may also help identify particular speakers, distinguish voices, sounds, homogenous segments, and audio clusters.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, other examples may include from the one particular value and/or to the other particular value. Similarly, when values are expressed as approximations, by use of the antecedent “about,” it will be understood that the particular value forms another example. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate examples, can also be provided in combination in a single example. Conversely, various features of the disclosed subject matter that are, for brevity, described in the context of a single example, can also be provided separately or in any sub-combination. Further, any reference to values stated in ranges includes each and every value within that range. Any documents cited herein are incorporated herein by reference in their entireties for any and all purposes.

In various aspects, systems and methods enable contextual collaborations for conferencing systems, methods, and devices. Contextual analyses may enable locating and mapping participants with respect to interactive devices, such as cameras, whiteboards, displays, furniture, and other objects within a room. As such, contextual awareness may be developed to improve conferencing communications and collaborations. Media content may be shared seamlessly and securely, and enable improved content sharing in a natural, realistic manner. In various examples radio signals, such as ultra-wideband (UWB) radio signals may be used to locate, authenticate, identify, and map individual participants within a location, such as a conference room. In various examples, wearable devices, such as smart glasses, a smart watch, and the like may assist in contextual awareness and identifying participant actions with respect to the conferencing device.

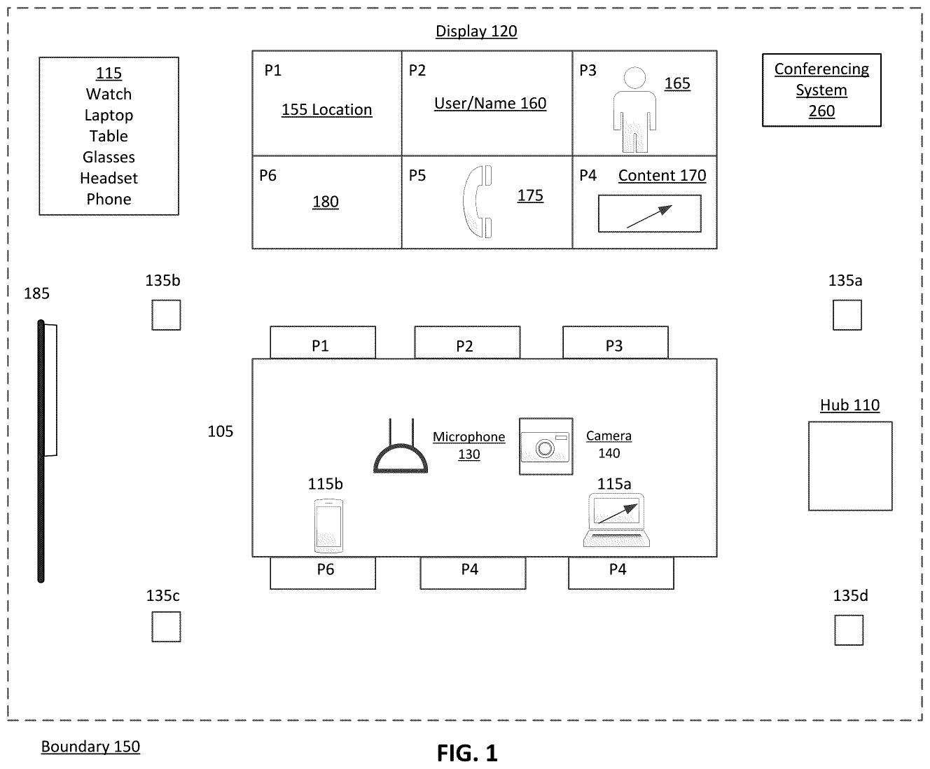

FIG. 1 illustrates an example contextual collaboration environment in accordance with the present disclosure. A hub 110, as further discussed herein, may assist in facilitating a conference operated by a conferencing device. The conferencing device may be configured to enable at least one of audio or visual communication between a group of participants. The participants may be located locally, for example within a conference room (see, e.g., room boundary 150), remotely, or a combination of both. The conferencing device may enable users to share video via a camera associated with the conferencing device (e.g., a phone or laptop camera, a room camera 140, a camera associated with a participant device 115, etc.), audio via at least one microphone associated with the conferencing device (e.g., microphone 130, distributed microphones 135a-d, microphone associated with a participant device 115, etc.), and content. Content may include but is not limited to auditory media, visual media, audiovisual media, and the like. Content may include physical content, such as handwritten notes and whiteboard writings, and virtual content, such as slides, graphs, and other items shareable via a computing device.

A plurality of devices, including but not limited to participant devices 115 (e.g., laptop 115a, smartphone 115b, smart glasses, smart watch, headset, tablets, etc.), a microphone 130, a distributed microphone system 135a, 135, b, 135, 135d, and a display 120 may be in remote communication with the hub 110. The remote communication may include radio communication and utilize ultra-wideband radio waves. The hub 110 may utilize the remote communication to identify a location of a participant device 115. The location of the participant device 115 may then be communicated to the conferencing device.

In accordance with the present disclosure, participant location may be provided to other participants associated with the conferencing device, e.g., all participants of a conference. The conferencing device may be associated with a display 120, which may provide a visual representation of all conference participants. For example, participants located in positions P1-P6 may be provided on the display 120, in respective display sections locations maintaining a correspondence between P1-P6. Content shared by individual users P1-P6, such as video content, media content, and the like, may be provided at a section of the display that respectively corresponds to P1-P6, and where they are located within the room 150. As discussed herein, the hub may assist in determining a participant's interaction with the conferencing based, for example, on the participant's movement, use of a device associated with the user and/or conferencing device, and the like. The hub may then communicate with the conferencing to update the display 120.

The visual of conference attendees on the display 120 may further include, but is not limited to content 160, e.g., content shared by a participant, an image 175 and/or live video associated with a participant 165, a name 170 associated with a participant, or a location of one or more attendees 175. In examples, a section of the screen as well as a location of the displayed shared on the display.

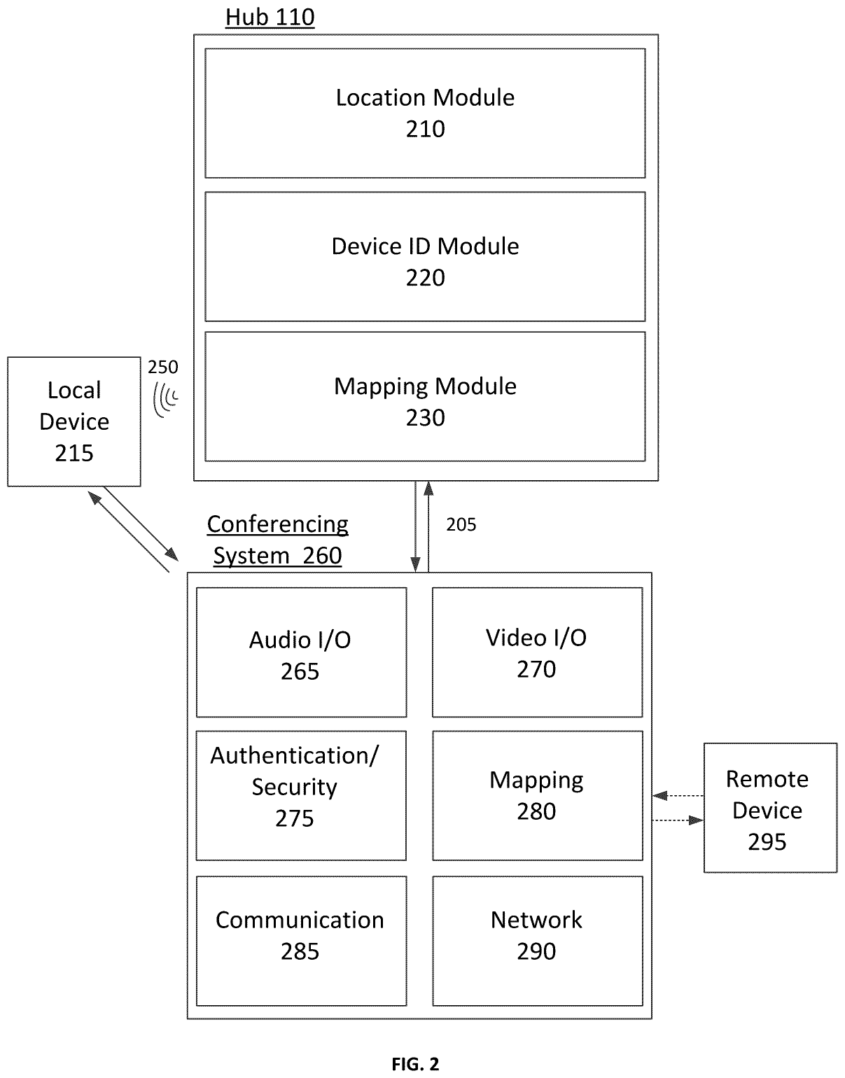

FIG. 2 illustrates an overview of a relationship between the hub 110, a conferencing device 260, local devices 215, and remote devices 295, in accordance with the present disclosure. In an example, the hub may be in network communication 205 with a conferencing device 260. The communication may be local or remote, wired, or wireless, depending on the desired configuration. Local devices 215 may be in wireless communication with the hub, and in some instances, remotely connected to the conferencing device as well. For example, a laptop within a conference room may emit UWB radio signals received at hub 110, and wired or wirelessly connected to the conferencing device. Remote devices 295 refer to devices not connected to the hub 110 but may communicate with conferencing device 260. Remote devices may be, for example, conference participants outside of a room in which the hub is located.

The hub 110 may serve to facilitate local device actions and interactions with the conferencing device. The hub 110 includes a location module 210, a device identification module 220, and an option mapping module 230. The location module 210 assists in determining a location of the local device. The location module 210 may process signals, such as radio signals, and specifically UWB radio signals emitting from a local device 215.

The location module 210 may utilize various location tracking techniques, such as Angle of Arrival (AoA) to determine the location of the local device 215. In AoA techniques, angular directions of the received signals (e.g., UWB radio signals) at the hub may be used to determine the location of the device. The elevation and azimuth directions, along with a known location of the hub and the phase of those received signals may provide the information necessary for the hub to determine where the device is located. In various examples, radio signals from the device may be processed continuously or at certain time intervals (e.g., every few seconds, minutes, etc.). The device location may be provided to the conferencing device for further use and application, as discussed herein.

The device identification module 220 utilizes received signals from the local device to identify the device, and in some aspects, the participant. The device, and optional participant identification may be provided to the conferencing device 260. Device identification may serve as an optional security safeguard, allowing a participant to join a call on the conferencing device only if the device is properly associated with and allowed access to the conference. The device identification module 220 further assists, along with the location module, in providing information about a participant's location within a conference room.

The mapping module 230 is an optional feature, which may provide information for a visual mapping of users associated with devices that are located and tracked within a conference room. In various aspects, as discussed herein, a plurality of devices, may be respectively associated with a participant at a location in a room (see, e.g., P1-P6 in FIG. 1). The mapping module utilize the location of respective devices to identify where each participant is seated in the room. If a participant moves around the room, a local device 215 located on or near the participant may provide the hub 110 and indication that the participant has moved locations. If the participant moves towards another local device, such as a display device or smartboard 185, the hub may determine that the participant may be interacting with the object, provide information to update at least one of the person's location and associated communication means (e.g., microphones, cameras, etc.) within that room. Such actions and interactions may be identified and updated at one or both of the hub 110 and conferencing device 260.

The conferencing device 260 may comprise a plurality of components to facilitate a conference, analyze participant interactions, and efficiently manage local and remote devices. The conferencing device may include modules managing audio input/output 265, video input/output 270, authentication/security 275, mapping 280, device communications 285, and network connections 290. Each of the modules may work alongside or in association with other conferencing device modules.

Audio input/output 265 relates to the enablement and management of auditory communications between participants via one or more devices associated with the hub 110 and conferencing device. For example, distributed microphones around a conference room may receive auditory signals from one or more participants. The audio input/output module may receive such auditory information and facilitate the audio distribution to other conference call participants. The conferencing device may, along with hub 110, determine one or more microphones within a room that is nearest to a current speaker, and activate the one or more microphones.

The video input/output 270 relates to the enablement and management of visual communications between participants via one or more devices associated with the hub 110 and conferencing device. For example, the video input/output 270 may assist in providing the appropriate image or video to display a speaker or content. Similar to the distributed microphones, given a set of cameras within a room, the video input/output module 270 may assist in determining a nearest camera to a participant, or a camera capturing content intended to be shared to other participants. In an example where the hub 110 determines that a participant has moved across or a room or changed positions, the video input/output 270 may process the updates to the video via camera changes, as provided by the hub 110, and ensure the video display to other participants is updated accordingly.

The authentication/security module 275 assists in validating participants and providing a secure connection between connected devices, such as the hub 110, local device(s) 215, and remote device(s) 290. In examples, the authentication/security module 275 may use information received from device ID module 220, and location information from the location module 210. Any or all of such information may be used to identify a participant attempting to join a conference, authenticate whether the participant and/or device are allowed to join the call, maintain a secure connection between connected devices, and/or monitor call security.

The conference system's location map 280 may assist in providing a visual display of participants in the call. The location map 280 may work in connection with the mapping module 230 of the hub 110. The mapping module 230 may provide a location-based map of participant position, based on the location received from respective devices. Location map 280 may assist in translating such information to a graphical output, such as via a video output to participants. The location map 280 may be visually presented in any of a plurality of formats, orientations, colors, and representations to communicate a location of participants. In an example, the location map may provide a graphical output similar to the display 120 in FIG. 1, wherein a participant's position on a display corresponds to a participant's physical position within a conference room. In FIG. 1, positions P1-P6 at table 105 correspond, respectively to the P1-P6 positions on the display 120. The location map may display at least one of an image, video, content, or text to be associated with a participant's position. In examples, the visual associated with each participant may correspond with the communication means (e.g., video, no video, name, text, image, etc.) associated with the participant at their physical location. Any of a plurality of graphical outputs, visuals, and the like may be enabled by the location map 280.

The communication module 285 may assist with processing communications between devices, such as the hub 110, local device(s) 215 and remote device(s) 295. The communication module 285 may work with the network module 290 to enable, maintain, and process devices joining and leaving the conference. The communication module 285 may interact with the hub 110 and to enable audio/visual communications, and/or determine a participant device which should be displayed, highlighted, providing audio communication, providing visual communication, and making seamless transitions between participants and devices. The communication module 285 may work alongside the authentication/security module 275 to connect or disconnect devices based on a security verification.

The network module 290 handles network connections, operations, and interactions with the hub 110 and various devices. The network module 290 may assist in maintaining a secure connection, along with the authentication/security module 275 and the communication module 285.

The conferencing system 260 and any or all of its associated modules may execute operations via one or more computing devices comprising a processor and memory, as discussed herein. Decisions and actions of each module may occur locally or remotely, such as at a remote server. In some instances, operations can occur on a serverless configuration, dynamically adjusting to demand and requests, as needed.

Accordingly, aspects of the present disclosure may enable significant improvements over traditional conferencing systems, and allow participants to connect, move, collaborate, and share content flexibly and naturally. The following examples highlight options and scenarios in which aspects of the present disclosure may be applied to facilitate an improved conferencing experience. It will be appreciated that the present disclosure is not limited to such examples and examples, and that a plurality of improved interactions and communications may occur on devices, systems, methods, and aspects discussed herein.

### Automatic Meeting and Roll Call Tagging

In a first example, the hub 110 may enable a conferencing device 260 to identify and securely authenticate the identity of a participant when they enter a room. A participant associated with a computing device, such as a wearable computing device (e.g., smart glasses, watch, etc.) or other computing device located on or near a user (e.g., a smart phone, laptop, tablet, etc.) may be identified via radio signals emitted from the device. When the user enters a room, radio signals, such as UWB signals emitted may be received by the hub. A positioning method, such as AoA, may accurately identify, from the radio signals, the participant's location, when they entered the room, and where they are, for example, at a specific chair in the room or at a conference table. The participant's name and information may be associated with the device and communicated to the hub via the radio signals. Accordingly, the participant's name and location may be tagged to their name on a display or on a video stream provided on the display, associated with the conferencing system.

In various aspects, participant identification, verification, and/or admittance into a conference may occur based on information, e.g., user information, provided by the device. This enables a seamless and efficient admittance of the participant into the conference. Participants need not perform additional actions to join a conference (e.g., logging in, providing conference security information, passwords, etc.), since the device ID provides information which may be used to verify the participant's eligibility to attend a conference, and identification of the participant. Instead, participants may enter a room or region associated with the hub, and automatically be located and admitted into the conference.

Such techniques may further provide improved privacy capabilities, since participants are not identified using facial recognition techniques, cameras, images, or other information usable by third party systems to identify and verify the individual. Instead, the admittance occurs based on the device ID and location information based on radio signals emitted from the device.

### Content Sharing

In another example, the hub may provide improved content sharing capabilities during a conference. A participant within a room may desire to interact with a person, object, or electronic device in the room, like an interactive whiteboard. In traditional methods, conveying the participant's movement within a room and an interaction with another person, object or electronic device may be difficult. Cameras may have to be moved, updated, or transitioned from a first location (e.g., a laptop camera pointing at a seated user) to capture the participant at their new location within the room (e.g., at a new seat, a podium or a whiteboard). Sound and microphones may be distorted since the participant moved locations and the original microphone capturing the participant's comments may no longer be in range of the participant at the new location.

However, using the hub and its location tracking features, when a participant moves from a first location, such as a chair (see, e.g., P1-P6 at table 105 in FIG. 1), to a second location, (e.g., towards the interactive whiteboard), the hub may identify the location change via the radio signals associated with a computing device located on or near the participant, such as smart glasses, smart watch, or other wearable device. Information from the wearable device may be securely transferred to the conferencing system, via the hub and/or wireless network connections, such as a Wi-Fi Direct (also known as Wi-Fi Peer-to-Peer (P2P)) connection. In some instances, the participant's wearable device may have an option to record video or capture a photo. Such photos and videos may be seamlessly transferred to the conferencing system.

If the user is wearing smart glasses, for example, the transferred photos or videos may include visuals of what the person is looking at or interacting with, such as a whiteboard. In another example, if the user is wearing a smart watch with the capability to capture audio, a movement from a first location, like a conference table, to a second location across the room, may cause a transition between audio capture a microphone at or near the first location, to the watch or another microphone at or near the second location. In yet another example, if the user moves from a first location to a second location near a smart device, such as an interactive whiteboard, aspects of the present disclosure may transfer video images of or associated with the first location to video images of the smart device (e.g., interactive whiteboard) at the second location. Content may then be shared with the rest of the participants in the call.

Accordingly, the present disclosure provides participants systems and methods to seamlessly transition between content sharing methods, and thereby, experience improved conference interactions. For example, a participant need not perform any manual actions to transition a transfer from one device to another, such as from a laptop camera to a camera capturing the interactive whiteboard. Instead, the hub may identify that the participant has performed an action, such as moving to a second location or approaching another computing device with a room, or otherwise attempting to interact with the conferencing system in some manner, and automatically transfer cameras, microphones, and devices, where needed to share intended content.

### Capturing Visual Content

Aspects of the present disclosure may further enable and enhance sharing of visual content. In examples, a participant may desire to share an item of visual content, which may include physical content, such as notes written on a piece of paper, or on a whiteboard, chalkboard or other device. In traditional methods, a participant may need to manually take a picture or focus a camera on the visual content they wish to share with the rest of the participants.

In accordance with the present disclosure, content sharing capabilities may be streamlined and improved through a smart determination identifying that the participant is attempting or intending to share visual content with other participants, and then seamlessly and efficiently transitioning devices, where necessary, to do so, and provide the visual content to the rest of the participants.

A computing device associated with the user may be in communication with the hub, and provide information indicative of an intended action or interaction by the participant with the conferencing system. For example, a wearable device, such as smart glasses, may capture visual images of a piece of paper upon which a participant is writing handwritten notes. The smart glasses may communicate such visual information to the hub, which may determine that the participant would like to share the handwritten notes with the other participants. Such interaction determinations may be made contextually, as discussed herein, based on captured audio and/or visual information. Visual images of the handwritten notes may be enough to indicate that a participant would like to share. Visual images along with audio content, such as audio by a participant indicative of a desire or intent to share such notes, by virtue of the participant writing the notes being an active speaker, or any of a combination of factors, may provide contextual clues indicating a desire or intent to share the visual content.

Accordingly, once the visual content sharing determination is made, the participant's device, in this example, the smart glasses, may provide the participant an option to record video or capture photos via the device for sharing with the other participants. Upon approval by the participant, which can occur via an alert, indication, automatically, or by some notification, the captured photo or video may be securely transferred the conferencing system, for example, using a Wi-Fi Direct/Wi-Fi P2P connection. The conferencing system may then provide the shared content with the rest of the participants on the call.

### Audio/Video Enhancements

Aspects of the present disclosure may improve audio and visual experiences during conferences. In an example, distributed microphones may be positioned around a conference room. Distributed microphones may be positioned like microphones 135a-d and microphone 130 FIG. 1, or otherwise positioned around a room. Based on location information obtained from a participant device, the hub may determine that a participant is moving or has moved from one location in the room to another. Based on the participant's location, the microphones closest to the participant may be associated with the participant such that when the participant is an active speaker, those nearest microphones are utilized to capture the audio. The set of microphones associated with the user may also be continually updated as the speaker moves around the room. In this manner, the active speaker may have audio rendered from the best and/or closest rendering device within the room.

In some cases, a closest microphone may be activated for input using speaker diarization. Speaker diarization may segment incoming audio into homogenous segments based on speaker identity. As such, different speakers may be identified, and one or more microphones from the set of distributed microphones may be associated with respective speakers. In this manner, the audio experience for the call may be enhanced, and optimized by associating the most appropriate microphones for each speaker.

In another example, where multiple microphones may receive audio from a speaker, higher fidelity microphone beamforming may be supported and utilize speaker location information. In some aspects, microphone beamforming may reach an accuracy at a centimeter level of accuracy.

Similar improvements and efficiencies may be realized by applying the above techniques to cameras positioned within the conference room. In an example where multiple camera devices are located within a room, a speaker location may be used to determine which cameras within the room will provide the best visual of the speaker. As a speaker moves, for example, from a seat at a conference table (e.g., a position P1-P6 at table 105), to a podium or other position within the room, a camera providing a visual of the speaker may be updated from the seat to the podium or other position where the speaker moved to. In various aspects, such transitions may occur automatically, without any manual input required from the participant to update the camera and/or microphones. Accordingly, the updated video may be provided to other conference participants, thereby providing a seamless transition.

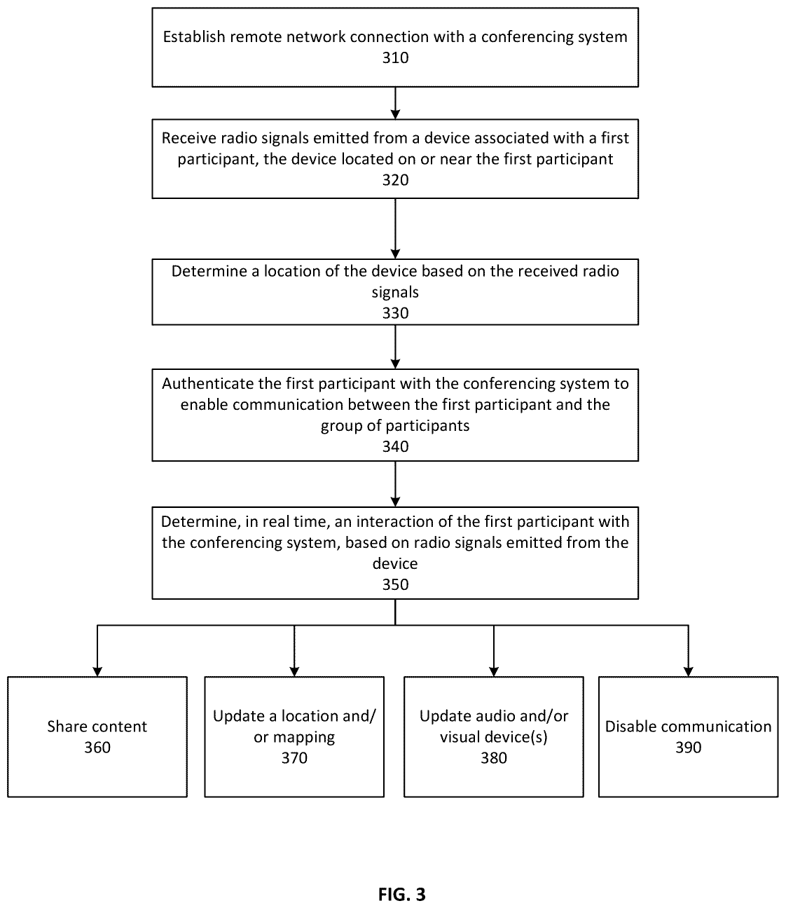

FIG. 3 illustrates a flowchart for performing contextual collaboration in accordance with aspects discussed herein. At block 310, a device (e.g., participant devices 115, local devices 215, augmented reality device 600) may establish a remote network connection with a conferencing system. In various examples, the conferencing system may be configured to enable at least one of audio or visual communication between a group of participants. In examples, the device may comprise a camera configured to capture content comprising at least one of an image or a video, and wherein the computing device is configured to securely provide the content to the conferencing system to display the content to the group of participants. In examples, content may be securely provided via a Wi-Fi Direct/Wi-Fi P2P connection.

At block 320, a device (e.g., participant devices 115, local devices 215, augmented reality device 600) may receive radio signals emitted from a device associated with a first participant, the device being located on or near the first participant. The device associated with the first participant may be a wearable device, a mobile computing device, a headset, glasses, a watch, a laptop, a table, or the like. Emitted radio signals may include ultra-wideband radio signals. In various aspects, the emitted radio signals may include information about the device and/or the participant associated with the device.

At block 330, a device (e.g., participant devices 115, local devices 215, augmented reality device 600)may determine a location of the device based on the received radio signals. As discussed herein, the location of the device may be determined using any of a plurality of techniques, including but not limited to an Angle of Arrival method. Location techniques may use at least one of phase information, azimuth information, elevation information, and similar information from the received signals.

At block 340, a device (e.g., participant devices 115, local devices 215, augmented reality device 600) may authenticate the first participant with the conferencing system to enable communication between the first participant and the group of participants. In various aspects, authenticating may comprise identifying the first participant to enable, via the conferencing system, a secure communication connection between the first participant and the group of participants.

At block 350, a device (e.g., participant devices 115, local devices 215, augmented reality device 600)may determine, in real time, at least one of an interaction of the first participant with the conferencing system or a current presence of the first participant, based on radio signals emitted from the device. In some aspects, the interaction may include at least one of a location change, a vocal interaction, and a sharing of content. Radio signals emitted from the first device to update on a display, in real time, a current presence of the first participant.

Based on the determined interaction, an action may be taken, including but not limited to sharing content 360, by a device (e.g., participant devices 115, local devices 215, augmented reality device 600), updating a location and/or mapping of the participant 370, by the device, updating at least one of an audio or visual devices to be associated with the participant, and disabling connection with the conferencing system 390, by the device. In an example, aspects may disable communication between the first participant and the group of participants of the conference when the location of the first participant exceeds a threshold distance. The threshold distance may be a room boundary (see, e.g., room boundary 150), a range of the hub, or a defined distance.

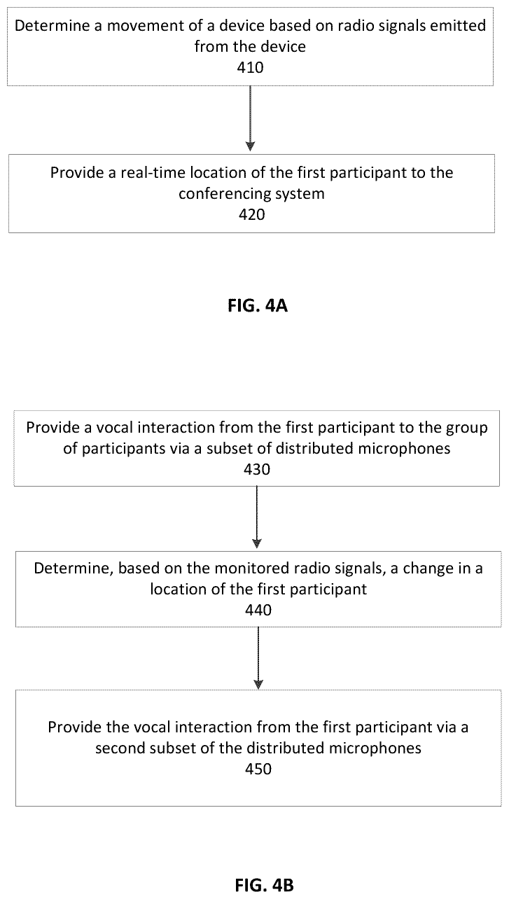

FIGS. 4A and 4B are flowcharts illustrating example actions in response to a determined interaction. In FIG. 4A, as discussed herein, a device (e.g., participant devices 115, local devices 215, augmented reality device 600) may determine a movement of a device based on the radio signals emitted from the device, at operation 410. The movement may be determined via the hub, and utilize location tracking methods such as AoA. Based on the movement, a device (e.g., participant devices 115, local devices 215, augmented reality device 600) may provide a real time location of the first participant to the conferencing system, at operation 420. The conferencing system may receive the real time location, and perform any of a plurality of actions in response to the movement. Such actions may include but are not limited to updating a graphic or visual corresponding the participant, update a map or image locating the participant (e.g., a conference table mapping, as described herein), connect or disconnect to a nearby device, or disable communication with the participant's device.

In an example, aspects may disable communication between the first participant and the group of participants when the real time location exceeds a threshold distance. As discussed herein, the threshold distance may be a room boundary (see, e.g., room boundary 150), a range of the hub, or a defined distance. Accordingly, aspects of the present disclosure may track the first participant based on the radio signals emitted from the device, and provide a real time location of the first participant to the conferencing system.

FIG. 4B illustrates another interaction example, wherein systems and methods (e.g., performed by a device (e.g., participant devices 115, local devices 215, augmented reality device 600))may provide a vocal interaction from the first participant to the group of participants via a first subset of the distributed microphone, at operation 430, and may determine, based on the monitored radio signals, a change in a location of the first participant, at operation 440, and may provide the vocal interaction from the first participant via a second subset of the distributed microphones, at operation 450. According to an aspect, the second subset may include one or more microphones in closest proximity to the first participant. According to another aspect, the visual representation may be a mapping of the group of participants.

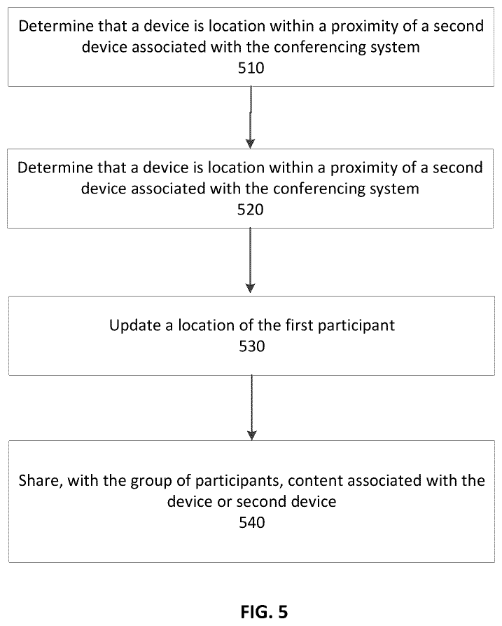

FIG. 5 provides a flowchart for updating shared content from a participant, based on the participant's location. In an aspect of the present disclosure, systems and methods (e.g., performed by devices, such as participant devices 115, local devices 215, augmented reality device 600)may determine that a device (e.g., participant devices 115, local devices 215, augmented reality device 600)is located within a proximity of a second device (e.g., other participant devices 115, other local devices 215, other augmented reality device 600)associated with the conferencing system, at block 510. The second device may be configured to share content with the group of participants. Content may include photos, videos, text, and/or the like. In various examples, the second device may include at least one of a camera, a whiteboard, a television, a monitor, a visual communication device, a vocal communication device, or a display.

At block 520, a device (e.g., participant devices 115, local devices 215, augmented reality device 600) may determine that a location of the first participant may be updated and content associated with the device (e.g., participant devices 115, local devices 215, augmented reality device 600) or the second device (e.g., participant devices 115, local devices 215, augmented reality device 600) may be shared with the group of participants. In an example, a participant may be located at a conference table, and/or sharing content from a computing device. The participant may then walk across the room to an interactive whiteboard, from which the user may desire to take and share notes to brainstorm with the group of participants on the call. Based on a signal emitting device (e.g., participant devices 115, local devices 215, augmented reality device 600) or another device located on or near the participant, such as a smart watch, smart glasses, or having a smart phone, the hub 110 may determine that the participant has moved. Based on a signal emitted from the interactive whiteboard (e.g., whiteboard 185), or based on a known location of the whiteboard device, the hub may determine that the participant has moved near the whiteboard, thereby suggesting an intent to interact with the whiteboard. Based on the proximity detection, a determination may be made to share content from the whiteboard. In the example, the participant need only move towards and start interacting with the whiteboard, and the shared content may seamlessly transition to the whiteboard. Accordingly, if the participant moves back towards their original seat, or to a different location in the room with a third device, then aspects of the present disclosure may transition content sharing based on the one or more device(s) at the new location.

At block 530, a device (e.g., participant devices 115, local devices 215, augmented reality device 600) may update a location of the first participant. A location module (e.g., location module 210) may utilize various location tracking techniques, such as Angle of Arrival (AoA) to determine the location of the device. In some examples, the device location may be tracked and/or refreshed at particular intervals. In an instance in which a change in location is detected, the change in location may be associated and/or assumed to be indicative of a change in the location of the first participant.

At block 540, a device (e.g., participant devices 115, local devices 215, augmented reality device 600) may share, with the group of participants, content associated with the device or the second device. As discussed herein, the location of the device may be associated with a change in location of the first participant. In an instance in which the participant's location is updated, the device may share the content with the second device.

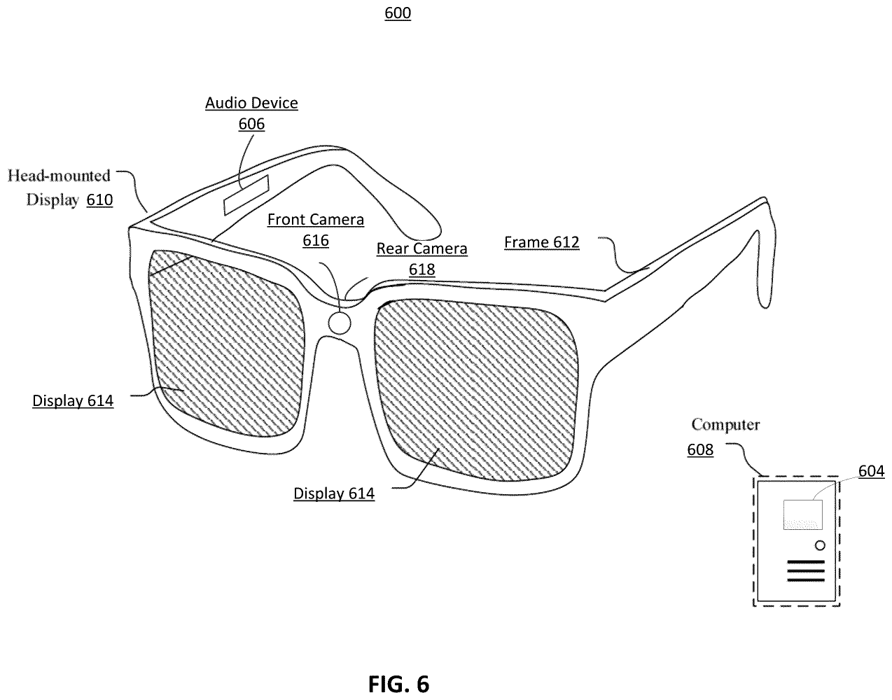

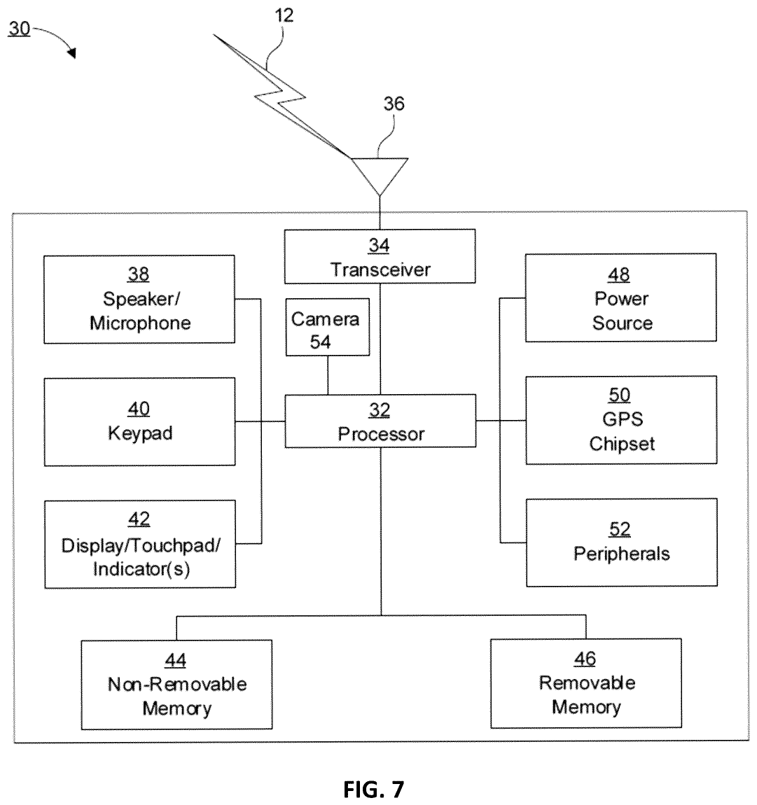

FIG. 6 illustrates an example augmented reality system 600. The augmented reality system 600 may include a head-mounted display (HMD) 610 (e.g., glasses) comprising a frame 612, one or more displays 614, and a computing device 608 (also referred to herein as computer 608). The displays 614 can be transparent or translucent allowing a user wearing the HMD 610 to look through the displays 614 to see the real world and displaying visual augmented reality content to the user at the same time. The HMD 610 may include an audio device 606 (e.g., speaker/microphone 38 of FIG. 6) that can provide audio augmented reality content to users. The HMD 610 may include one or more cameras 616 which may capture images and videos of environments. The HMD 610 may include an eye tracking system to track the vergence movement of the user wearing the HMD 610. In one example, the camera 616 can be the eye tracking system. The HMD 610 may include a microphone of the audio device 606 to capture voice input from the user. The augmented reality system 600 may further include a controller 618 (e.g., processor 32 of FIG. 7) comprising a trackpad and one or more buttons. The controller may receive inputs from users and relay the inputs to the computing device 608. The controller can also provide haptic feedback to users. The computing device 608 may be connected to the HMD 610 and the controller through cables or wireless connections. The computing device 608 may control the HMD 610 and the controller to provide the augmented reality content to and receive inputs from one or more users. In some examples, the controller 618 may be a standalone controller or integrated within the HMD 610. The computing device 608 may be a standalone host computer device, an on-board computer device integrated with the HMD 610, a mobile device, or any other hardware platform capable of providing augmented reality content to and receiving inputs from users. In some examples, HMD 610 may include an augmented reality system/virtual reality system (e.g., augmented reality system 600).

It is further understood according to the aspects of the present disclosure that the smart glasses may be used in conjunction with the Metaverse. The Metaverse is understood to be a world including a collection of virtual time and space. The virtual world may be created by scientific and technological means and may be used in conjunction with the real world. It is understood that many activities currently only attainable by traveling to physical locations in the real world may be implemented in the Metaverse. This may include, for example, social events such as concerts and sporting events and/or the like. This may also include business related activities, for example, meeting with colleagues via avatars.

FIG. 7 illustrates a block diagram of an exemplary hardware/software architecture of a UE 30. As shown in FIG. 7, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 can also include a camera 54. In an example, the camera 54 is a smart camera configured to sense images appearing within one or more bounding boxes. The UE 30 can also include communication circuitry, such as a transceiver 34 and a transmit/receive element 36. It will be appreciated the UE 30 may include any sub-combination of the foregoing elements while remaining consistent with examples.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 can execute computer-executable instructions stored in the memory (e.g., memory 44 and/or memory 46) of the node 30 in order to perform the various required functions of the node. For example, the processor 32 can perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 can be configured to transmit signals to, or receive signals from, other nodes or networking equipment. For example, the transmit/receive element 36 can be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

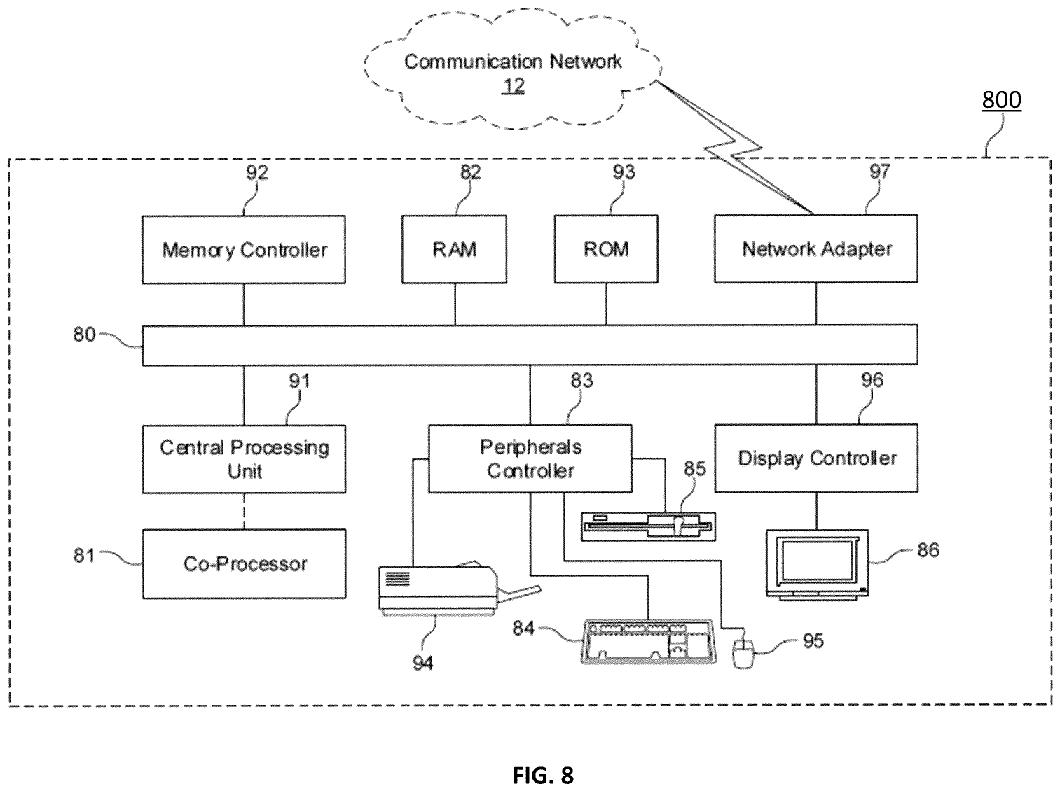

FIG. 8 is a block diagram of an exemplary computing system 800 which can also be used to implement components of the system or be part of the UE 30. The computing system 800 can comprise a computer or server and can be controlled primarily by computer readable instructions, which can be in the form of software, wherever, or by whatever means such software is stored or accessed. Such computer readable instructions can be executed within a processor, such as central processing unit (CPU) 91, to cause computing system 800 to operate. In many workstations, servers, and personal computers, central processing unit 91 can be implemented by a single-chip CPU called a microprocessor. In other machines, the central processing unit 91 can comprise multiple processors. Coprocessor 81 can be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 800 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories can include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 can be controlled by memory controller 92. Memory controller 92 can provide an address translation function that translates virtual addresses into physical addresses as instructions are executed. Memory controller 92 can also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 800 can contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 800. Such visual output can include text, graphics, animated graphics, and video. Display 86 can be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 800 can contain communication circuitry, such as for example a network adaptor 97, that can be used to connect computing system 800 to an external communications network, such as network 12 of FIG. 7, to enable the computing system 800 to communicate with other nodes (e.g., UE 30) of the network.

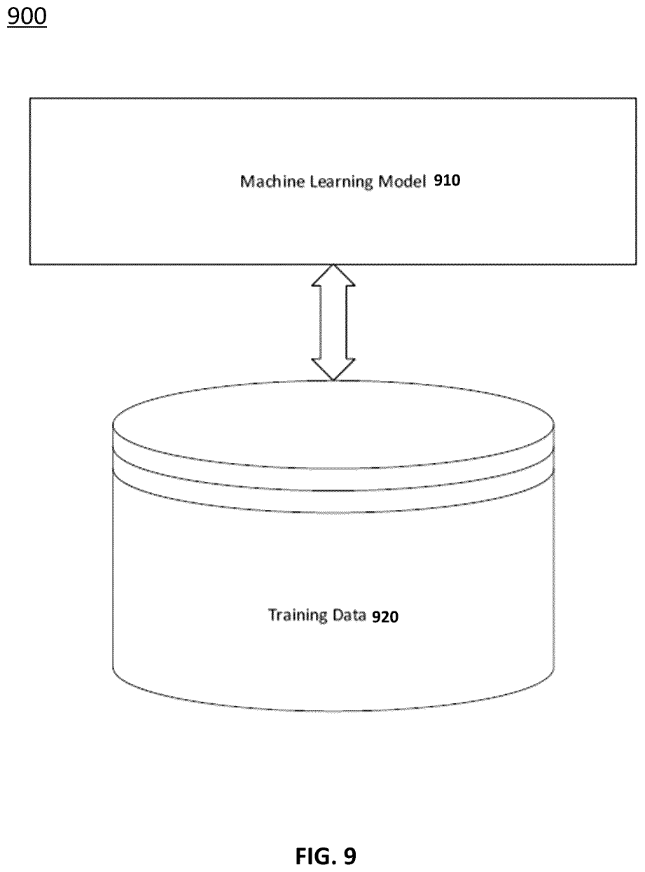

FIG. 9 illustrates a framework 900 employed by a software application (e.g., computer program code, software, an algorithm(s)) for evaluating attributes of one more devices, participants, movements, and participant locations, as discussed herein. For example, framework 900 may determine that a device (e.g., an individual's laptop) is often used from a particular location. The framework 900 may utilize this information to anticipate a timing and location of the user and/or user device. Such information may be used increase content transition speed, authentication processes, and the like. The framework 900 may be hosted remotely. Alternatively, the framework 900 may reside within the UE 30 shown in FIG. 7 and/or be processed by the computing system 800 shown in FIG. 8. The machine learning model 910 may operably be coupled to the stored training data in a database 920.

In an example, the training data 920 may include attributes of thousands of objects. For example, the object(s) may be a smart phone, person, book, newspaper, sign, car, and/or the like. Attributes may include but are not limited to the size, shape, orientation, position of the object(s), etc. The training data 920 employed by the machine learning model 910 may be fixed or updated periodically. Alternatively, the training data 920 may be updated in real-time based upon the evaluations performed by the machine learning model 910 in a non-training mode. This is illustrated by the double-sided arrow connecting the machine learning model 910 and stored training data 920.

In operation, the machine learning model 910 may evaluate attributes of images/videos obtained by hardware (e.g., UE 30, participant devices 115, local devices 215, augmented reality device 600, etc.). For example, the camera 54 of the UE 30 shown in FIG. 7 senses and captures an image/video, such as for example approaching or departing objects, object interactions, hang gestures, and/or other objects, appearing in or around a bounding box of a software application. The attributes of the captured image (e.g., captured image of an object or person may then be compared with respective attributes of stored training data 920 (e.g., prestored objects). A confidence score may be determined based on the likelihood of similarity between each of the obtained attributes (e.g., of the participant location, a captured image of an object(s), a content share between device(s)) and the stored training data 920 (e.g., prestored objects). Accordingly, various attributes, including but not limited to device movements based on signals (e.g., radio signals), a real-time location detection, auditory signals (e.g., vocal interactions, speaking, etc.), content sharing information (e.g., where content is displayed to/from), and the like may be collected, and historical data and associations may provide training data, confidence levels, and thresholds for future events and actions. In one example, if the confidence score exceeds a predetermined threshold, the attribute is included in a description that may be communicated to the user via a user interface of a computing device (e.g., UE 30, participant devices 115, local devices 215, augmented reality device 600,). In another example, the description may include a certain number of attributes which exceed a predetermined threshold to share with the user. The sensitivity of sharing more or less attributes may be customized based upon the needs of the particular user.

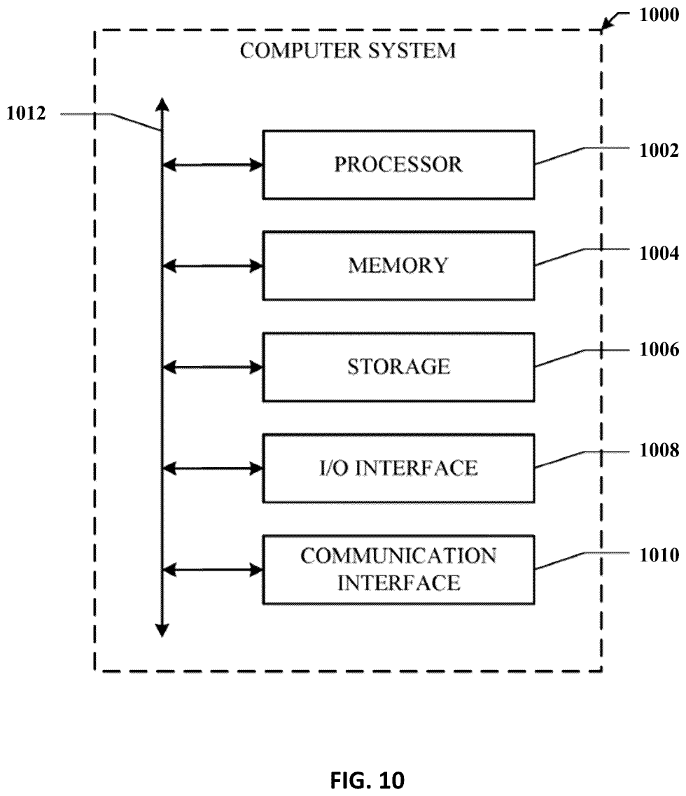

FIG. 10 illustrates an example computer system 1000. In examples, one or more computer systems 1000 perform one or more steps of one or more methods described or illustrated herein. In particular examples, one or more computer systems 1000 provide functionality described or illustrated herein. In various examples, software running on one or more computer systems 1000 performs one or more steps of one or more methods described or illustrated herein or provides functionality described or illustrated herein. Examples include one or more portions of one or more computer systems 1000. Herein, reference to a computer system can encompass a computing device, and vice versa, where appropriate. Moreover, reference to a computer system can encompass one or more computer systems, where appropriate.

This disclosure contemplates any suitable number of computer systems 1000. This disclosure contemplates computer system 1000 taking any suitable physical form. As example and not by way of limitation, computer system 1000 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example, and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In various examples, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In various examples, processor 1002 includes hardware for executing instructions, such as those making up a computer program. As an example and not by way of limitation, to execute instructions, processor 1002 can retrieve (or fetch) the instructions from an internal register, an internal cache, memory 1004, or storage 1006; decode and execute them; and then write one or more results to an internal register, an internal cache, memory 1004, or storage 1006. In particular examples, processor 1002 can include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular examples, processor 1002 can include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In various examples, memory 1004 includes main memory for storing instructions for processor 1002 to execute or data for processor 1002 to operate on. As an example and not by way of limitation, computer system 1000 can load instructions from storage 1006 or another source (such as, for example, another computer system 1000) to memory 1004. Processor 1002 can then load the instructions from memory 1004 to an internal register or internal cache. To execute the instructions, processor 1002 can retrieve the instructions from the internal register or internal cache and decode them. During or after execution of the instructions, processor 1002 can write one or more results (which can be intermediate or final results) to the internal register or internal cache. Processor 1002 may then write one or more of those results to memory 1004. In particular examples, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which can each include an address bus and a data bus) can couple processor 1002 to memory 1004. Bus 1012 can include one or more memory buses, as described below. In some examples, one or more memory management units (MMUs) reside between processor 1002 and memory 1004 and facilitate accesses to memory 1004 requested by processor 1002. In particular examples, memory 1004 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 1004 can include one or more memories 1004, where appropriate. Although this disclosure describes and illustrates particular memory, this disclosure contemplates any suitable memory.

In some examples, storage 1006 includes mass storage for data or instructions. As an example, and not by way of limitation, storage 1006 can include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 can be internal or external to computer system 1000, where appropriate. In some examples, storage 1006 is non-volatile, solid-state memory. In particular examples, storage 1006 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 can include one or more storage control units facilitating communication between processor 1002 and storage 1006, where appropriate. Where appropriate, storage 1006 can include one or more storages 1006. Although this disclosure describes and illustrates particular storage, this disclosure contemplates any suitable storage.

In various examples, I/O interface 1008 includes hardware, software, or both, providing one or more interfaces for communication between computer system 1000 and one or more I/O devices. Computer system 1000 may include one or more of these I/O devices, where appropriate. One or more of these I/O devices can enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In various examples, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. One or more portions of one or more of these networks can be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular examples, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the examples described or illustrated herein that a person having ordinary skill in the art would comprehend. The scope of this disclosure is not limited to the examples described or illustrated herein. Moreover, although this disclosure describes and illustrates respective examples herein as including particular components, elements, feature, functions, operations, or steps, any of these examples can include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples can provide none, some, or all of these advantages.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method for contextual conferencing collaboration, comprising:
establishing a remote network connection with a conferencing device, the conferencing device configured to enable at least one of an audio communication or a visual communication between a group of participants;
receiving radio signals emitted from a device associated with a first participant, the device being located on or near the first participant;
determining a location of the device based on the received radio signals;
authenticating the first participant with the conferencing device to enable communication between the first participant and the group of participants; and
determining, in real time, an interaction of the first participant with the conferencing device, based on the received radio signals emitted from the device.

2. The method of claim 1, wherein the radio signals comprise ultra-wideband radio signals.

3. The method of claim 1, wherein the device comprises at least one of a wearable device, a headset, glasses, a watch, a mobile computing device, a laptop, or a tablet.

4. The method of claim 1, wherein determining the location of the device utilizes an Angle of Arrival (AoA) of the received radio signals.

5. The method of claim 1, wherein the authenticating the first participant comprises identifying the first participant to enable, via the conferencing device, a secure communication connection between the first participant and the group of participants.

6. The method of claim 1, further comprising:
receiving a request to share content from the device; and
providing the content to the conferencing device to enable visual display of the content to the group of participants.

7. The method of claim 1, further comprising:
determining that the device is located within a proximity of a second device associated with the conferencing device, the second device configured to share content with the group of participants; and
updating a location of the first participant and sharing, with the group of participants, content associated with the device or the second device.

8. The method of claim 7, wherein the second device comprises at least one of a camera, a whiteboard, a television, a monitor, a visual communication device, or a display.

9. The method of claim 1, further comprising:
determining a movement of the device based on the received radio signals emitted from the device; and
providing a real time location of the first participant to the conferencing device.

10. The method of claim 9, further comprising:
disabling communication between the first participant and the group of participants in an instance in which the real time location exceeds a threshold distance.

11. The method of claim 10, wherein the threshold distance is associated with a room boundary.

12. A system comprising:
an apparatus comprising one or more processors; and
at least one memory storing instructions, that when executed by the one or more processors, cause the apparatus to:
establish a remote network connection with a conferencing device, wherein the conferencing device is associated with a first participant of a conference, and wherein the conference is configured to enable at least one of an audio communication or a visual communication between a group of participants;
receive radio signals emitted from a device associated with the first participant, the device being located on or near a first participant;
determine a location of the device based on the received radio signals;
authenticate the first participant with the conferencing device to enable communication between the first participant and the group of participants; and
monitor a plurality of radio signals emitted from the device to update via a display, in real time, a current presence of the first participant.

13. The system of claim 12, wherein when the one or more processors further execute the instructions, further causes the apparatus to:
receive auditory information from an audio device comprising a plurality of distributed microphones;
provide a vocal interaction from the first participant to the group of participants via a first subset of the distributed microphones;
determine, based on the monitored plurality of radio signals, a change in a location of the first participant; and
provide the vocal interaction from the first participant via a second subset of the distributed microphones.

14. The system of claim 13, wherein the second subset comprises one or more microphones in a closest proximity to the first participant.

15. The system of claim 12, wherein the visual communication comprises a mapping of the group of participants.

16. The system of claim 12, wherein the apparatus comprises a camera configured to capture content comprising at least one of an image or a video, and wherein the apparatus is configured to securely provide the content to the conferencing device to enable display of the content to the group of participants.

17. The system of claim 16, wherein the content is securely provided via a Wi-Fi Direct connection.

18. A non-transitory computer readable medium storing computer-executable instructions, which when executed, cause:
establishing a remote network connection with a conferencing device, wherein the conferencing device is configured to enable at least one of an audio communication or a video communication between a group of participants;
receiving radio signals emitted from a device associated with a first participant, the device being located on or near the first participant;
determining a location of the device based on the received radio signals;
authenticating the first participant with the conferencing device to enable communication between the first participant and the group of participants; and
determining, in real time, an interaction of the first participant with the conferencing device, based on radio signals emitted from the device.

19. The non-transitory computer readable medium of claim 18, wherein the interaction is at least one of a location change, a vocal interaction, or a sharing of content.

20. The non-transitory computer-readable medium of claim 18, wherein the instructions, when executed, further cause:
tracking the first participant based on the received radio signals emitted from the device; and
providing a real time location of the first participant to the conferencing device.
